(19) United States
(12) Patent Application Publication
(10) Pub. No.: US 2024/0227383 A1
(43) Pub. Date: Jul. 11, 2024

(54) SEALING SYSTEM

(71) Applicant: BOBST BIELEFELD GMBH, Bielefeld (DE)

(72) Inventor: Frank RUDOLPH, Versmold (DE)

(73) Assignee: BOBST BIELEFELD GMBH, Bielefeld (DE)

(21) Appl. No.: 18/403,989

(22) Filed: Jan. 4, 2024

(30) Foreign Application Priority Data
Jan. 10, 2023 (EP) 23150964.7

(51) Int. Cl. B41F 9/06

(52) U.S. Cl. CPC B41F 9/068; B41F 9/063

(57) ABSTRACT

The invention relates to a sealing system, the sealing system comprising two first sealing members (62) which are each disposed at opposite lateral ends (56) of a doctor blade chamber (48), and two second sealing members (64) which are each disposed at opposite lateral ends (60) of the rotatable roller (46), wherein in operational mode, each of the two first sealing members (62) is in rotating contact with each of the two second sealing members (64) such that a leakage of ink at the opposite lateral ends (56) of the doctor blade chamber (48) is prevented.

The invention relates to a sealing system for a doctor blade assembly of a rotary printing press.

A typical doctor blade assembly used in a conventional rotary printing press accommodates a rotatable roller which picks up ink from a reservoir and deposits the ink onto another surface located opposite to the reservoir. Typically, the other surface is an anilox cylinder which subsequently transfers the ink to a plate cylinder on which a flexo plate is fixedly mounted. From the flexo plate, the ink is finally transferred to a substrate which is partially in contact with the perimeter of the plate cylinder. Such an assembly is also known as a printing unit.

In a conventional rotary printing press, a plurality of printing units is arranged around a perimeter of a central cylinder and around which a substrate in the form of a long web is guided along a substrate handling path. The substrate is printed with ink while being moved along the printing handling path from an unwinder to a winder station.

Hereby, the doctor blade assembly plays a crucial role in transferring ink from the reservoir to the rotatable roller. In order to prevent a leakage of ink between the reservoir filled with ink and the rotatable rotating roller, it is essential to provide a sealing to seal the opposite ends of the reservoir from the rotating roller.

There are different attempts known in the prior art to seal a doctor blade assembly. For example, EP 2 425 972 B1 describes an end seal for removable attachment to a doctor blade assembly which inhibits seal failure due to unintended seal movement. In detail, a pair of seals is exclusively attached to the housing of the doctor blade.

Another sealing is known from the DE 202 01 901 U1, the sealing for a doctor blade assembly is a rubber which is held at the opposite ends of the doctor blade chamber.

A further sealing is known from EP 2 821 228 B1. The document discloses a seal for a doctor blade device rotary printing press comprising a doctor blade contacting section with a front side engaged with a doctor blade of the doctor blade device and a rear side that is softer, more elastic or more resilient than the front side.

However, sealings used in doctor blade assemblies are subject to uncontrolled deformation and severe wear since the sealing is during the operational mode of the press always in rotating contact with the rotatable roller. Thus, existing doctor blade assemblies often suffer from unintended ink leakage due to severe wear of the sealings.

Furthermore, there are a myriad of sealing systems available on the market, so that not every sealing of a doctor blade chamber is suitable for each and every roller.

It is therefore an object of the present invention to provide a sealing system for a doctor blade assembly that overcomes at least one of the aforementioned disadvantages of the prior art.

This objective is achieved by a sealing system, the sealing system comprising two first sealing members which are disposed at opposite lateral ends of a doctor blade chamber which in operational mode is adapted to partially receive a rotatable roller for applying ink from the doctor blade chamber onto the roller. The sealing system further comprises two second sealing members which are each disposed at opposite lateral ends of the rotatable roller, which in operational mode is configured to extend partially into the doctor blade for receiving ink from the doctor blade chamber. In an operational mode, each of the two first sealing members is in rotating contact with each of the two second sealing members such that a leakage of ink at opposite lateral ends of the doctor blade chamber is prevented.

The basic idea of the invention is to provide two separate sealings instead of one single sealing, as known in the prior art. Typically, sealing systems for doctor blade assemblies are using merely a single sealing which is either disposed on the rotating roller or disposed on the doctor blade chamber. This often leads to an undesired severe wear of the single sealing. This issue is solved by the invention by using a two-part system, in which one part of the sealing is assigned to a doctor blade assembly and the other corresponding part of the sealing is assigned to the rotatable roller. By using two sealings, improved sealing properties of the doctor blade assembly can be achieved. Furthermore, the wear of the sealings is distributed between the two sealings such that the wear is reduced in general. As a result, a doctor blade assembly having a sealing system according to the invention has a longer running time compared to doctor blade assembles with prior art sealing systems.

According to a first aspect of the invention, each of the two first sealing members is formed as a semi-circle shaped bearing, each bearing has a curvature which corresponds to a curvature of a perimeter of the rotatable roller.

As a result, the first two sealing members are adapted to receive the rotatable roller in an operational mode. With other words, the doctor blade chamber with the two first sealings and the rotatable roller with the two second sealing members can interlock with each in a form-fitting manner, such that no gap is created between the doctor blade chamber and the rotatable roller.

According to another aspect of the invention, each of the two first sealing members is a lip seal.

A lip seal can be easily produced and mounted onto the doctor blade chamber. As such, the sealing system is cheap and can also be installed later on existing doctor blade assemblies.

According to another aspect of the invention, each of the two second sealing members is ring-shaped and extends continuously around the perimeter of the rotatable roller. The above described shape of the two second sealing members is preferred, since the complete perimeter of the rotatable roller is covered by the two second sealing members. Since the two second sealing members are arranged at the opposite lateral ends of the rotatable roller, the ink, which is retrieved from the ink reservoir by the rotatable roller cannot leak out at the lateral ends.

In another aspect of the invention, each of the two second sealing members is made from a harder material as each of the two first sealing members.

In an alternative embodiment, each of the two first second sealing members is made from a harder material as each of the two second sealing members.

The material composition of the two first sealing members and the two second sealing members can be chosen dependent on the ink used in the doctor blade assembly, respectively.

In a preferred embodiment, each of the two first sealing members is made from a slidable material, particularly wherein each of the two first sealing members is made from a material which is selected from the group consisting of ethylene propylene diene monomer rubber, polyvinylidene fluoride, fleece, polished steel or an alloy, thermoplastic polymer and combinations thereof.

Each of the two first sealing members may be made from ethylene propylene diene monomer rubber which is coated with polyvinylidene fluoride.

The above mentioned material compositions have been found out to work best for the two first sealing members.

In another aspect of the invention, each of the two second sealing members is made from a material which is selected from the group consisting of ethylene propylene diene monomer rubber, polyvinylidene fluoride, fleece, polished steel or an alloy, thermoplastic polymer and combinations thereof.

The material combination of the second sealing members can be selected arbitrary in view of the material of the first sealing members.

For example, each of the two first sealing members may be made from ethylene propylene diene monomer rubber which is coated with polyvinylidene fluoride, while each of the two second sealing members is made from a thermoplastic polymer.

In another preferred embodiment, this sealing system further comprises a lubrication unit which is adapted to lubricate a contact surface between each of the two first sealing members and each of the two second sealing members with a lubricant.

This provides the advantage that the contact surface between each of the two first sealing members and each of the two second sealing members is well lubricated when the printing unit is switched into the operational mode. In the operational mode the rotatable roller is in rotating contact with the doctor blade chamber. As a result, friction force is generated at the contact surface between each of the two first sealing members and each of the second sealing members which leads to an accelerated wear of the sealing. This can be effectively prevented by adding a lubricant to the contact surface in order to reduce the friction between the sealing elements. Thus, the lifetime of the sealing system is effectively prolonged.

In another preferred embodiment of the invention, the lubrication unit has a reservoir unit in which a lubricant is stored and which is selected from the group consisting of mineral oil and synthetic oil.

In principle, any mineral oil may be used as a lubricant.

Examples for mineral oil are, but not limited thereto, hexane, heptane, octane, nonane, decane, undecane and dodecane.

Examples for synthetic oil are, but not limited thereto, poly-alpha-olefin (PAO) and polyalkyleneglycol (PAG).

In another aspect, the lubrication unit further comprises a pump assigned to the reservoir unit, the reservoir unit being fluidly connected to at least one lubrication channel, the at least one lubrication channel extending from the reservoir unit towards a dispenser element which is assigned to the contact surface of each of the first sealing members and each of the second sealing members.

With the above described system, a lubricant can be provided in a fast and simple manner to the contact surface between each of the two first sealing members and each of the two second sealing members. Furthermore, the above described system allows that the lubricants can be stored separately from the doctor blade assembly in a space-efficient manner. If a lubrication of the contact surface is needed, the lubricant can be actively transported by the pump to the doctor blade assembly.

In an alternative embodiment, the lubrication unit has a compressed gas unit in which pressurized gas is stored, wherein the lubrication unit further comprises a gas channel and nozzle which are fluently connected to each other, and wherein the compressed gas unit is adapted to provide a gaseous lubricant between each of the first sealing members and each of the second sealing members such that in operation mode each of the first sealing members and each of the second sealing members are separated by a layer of gas.

Preferably, the gaseous lubricant is selected from the group of argon, air, nitrogen and mixtures thereof.

The above described embodiment is enabled to provide a curtain made out of a gaseous lubricant which is a very effective way to prevent the occurrence of friction forces at the contact surface between the first sealing member and the second sealing members. In the operational mode, the first and the second sealing members are always separated by a layer of gas, which is in particular of advantage because after the printing job is completed, there are no liquid lubricants to remove afterwards. Compared to a liquid lubrication system, the maintenance is improved since gaseous lubricants are easier to handle.

Depending on the ink used, the gaseous lubricant may be selected from the group consisting of argon, air, nitrogen and mixtures thereof.

For example, if the used ink is susceptible towards oxygen, the gaseous lubricant may be selected to be an inert gas such as argon or nitrogen.

Otherwise, it is more cost efficient to use air as a gaseous lubricant.

In the following, the invention will be described in detail by making reference to the annexed drawings, in which

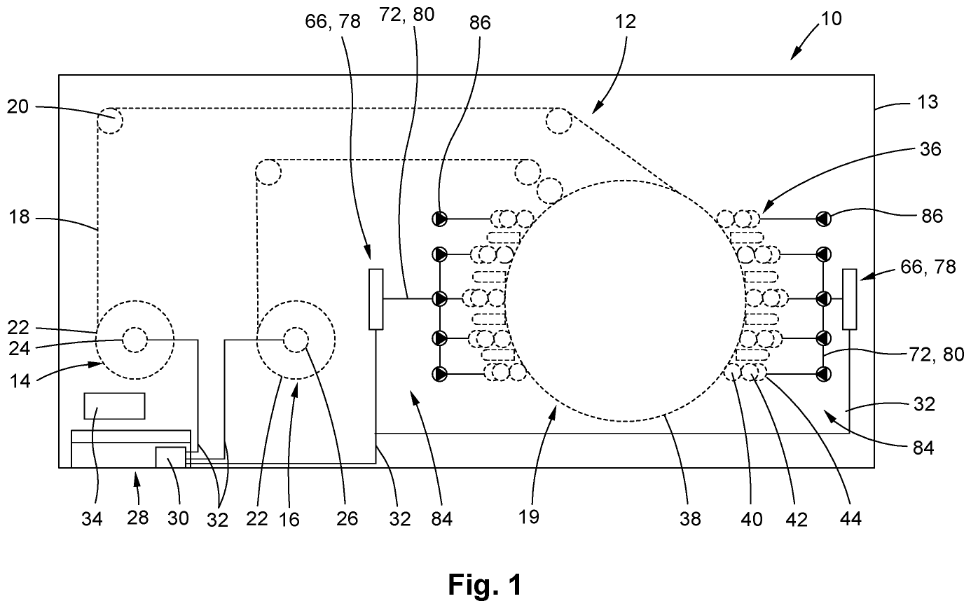

FIG. 1 is a scheme of a rotary printing press comprising the sealing system according to the invention;

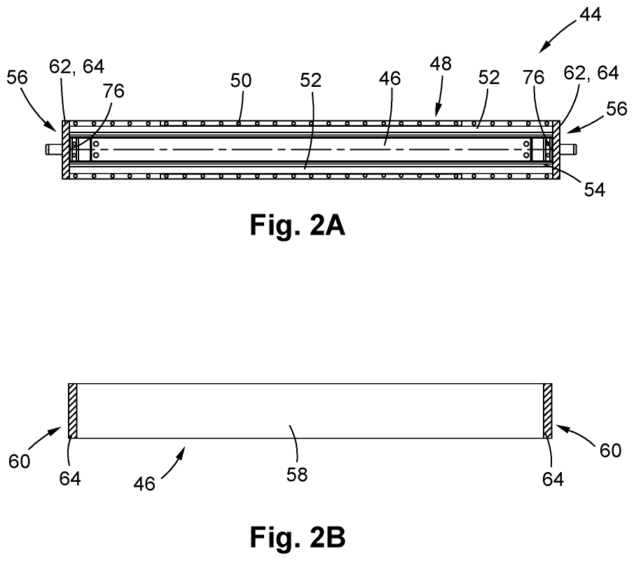

FIG. 2A is a top view onto a doctor blade assembly from FIG. 1, the doctor blade assembly comprising the sealing system according to the invention;

FIG. 2B is a top view onto a roller of doctor blade assembly from FIG. 2A;

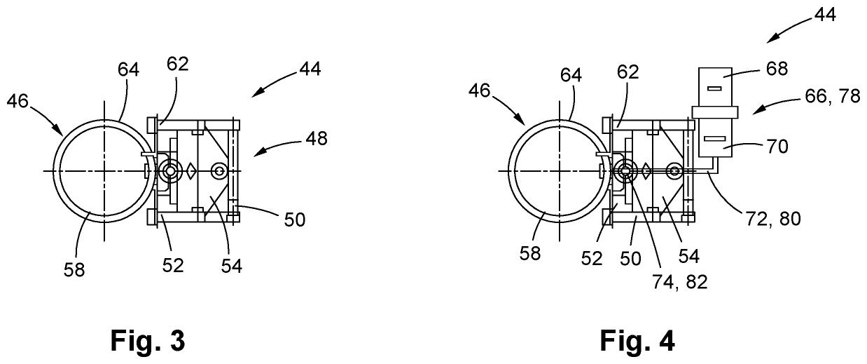

FIG. 3 is a cross-sectional view of the doctor blade assembly from FIG. 2A; and

FIG. 4 is a cross-sectional view of the doctor blade assembly of FIG. 2A, wherein an additional lubricant unit is attached to the doctor blade assembly.

FIG. 1 depicts a rotary printing press 10 according to the invention.

The rotary printing press 10 comprises a substrate transport system 12, the substrate transport system 12 being accommodated within a housing 13 of the rotary printing press 10.

In particular, the housing 13 completely encapsulates the substrate transport system 12.

The substrate transport system 12 comprises a winder station 14 and an unwinder station 16 which are configured to transport a substrate 18 along a printing handling path 19 from the unwinder station 16 to the winder station 14.

In principle, the substrate transport system 12 works as a conveyor road. For transporting the substrate 18 along the printing handling path 19 a plurality of rollers 20 are employed, each roller 20 being adapted to guide the substrate 18 within the housing 13 between unwinder station 16 and winder station 14.

The material of which the substrate 18 is made is not limited and may comprise paper, cardboard, metal foil, plastic and combinations thereof.

As it can be seen from FIG. 1, the substrate 18 has the shape of a tape (web) which extends continuously between unwinder station 16 and winder station 14. At each of the stations 14, 16 the substrate 18 is coiled to a substrate roll 22. At the winder station 14, the substrate roll 22 is carried by a winder cylinder 24 while at the unwinder station 16, the substrate roll 22 is carried by an unwinder cylinder 26.

Further, the rotary printing press 10 comprises a command station 28 to control the rotary printing press 10, particularly the substrate transport system 12.

A control unit 30 is assigned to the command station 28, wherein the control unit 30 is connected to the substrate transport system 12 via an electrical connection 32. In particular, the control unit 30 is connected via two connections 32 to the winder station 14 and the unwinder station 16, respectively.

Further, the control unit 30 is configured to control a speed of the substrate 18 which is moved through the substrate transport system 12 along the printing handling path 19. Therefore, the control unit 30 is particularly adapted to control the rotation speed and rotation direction of the winder cylinder 24 and the unwinder cylinder 26, respectively.

In particular, the command station 28 provides a user interface 34 to allow an operator to manually operate the control unit 30.

However, the control unit 30 may also be adapted to automatically control the rotation speed and rotation direction of the winder cylinder 24 and the unwinder cylinder 26.

The user interface 34 and the control unit 30 may be a monitor and computer, respectively.

The rotary printing press 10 further comprises at least one printing unit 36 which is arranged around the perimeter of a central cylinder 38. In addition, the at least one printing unit 36 is located adjacent to the printing handling path 19 extending circumferentially around the central cylinder 38.

As it can be seen in FIG. 1, there is more than one printing unit 36 arranged around the central cylinder 38. In fact, a plurality of printing units 36 is foreseen, each printing unit 36 providing at least one type of ink for printing the substrate 18.

In detail, each printing unit 36 comprises a plate cylinder 40 which is assigned to the printing handling path 19 surrounding the central cylinder 38. The plate cylinder 40 comprises a flexible relief plate (here not shown), also known as flexo plate, for transferring the ink to the front side of the substrate 18. In detail, the flexo plate extends along a perimeter of the plate cylinder 40 and is fixedly mounted thereto.

Opposite to the substrate handling path 19, the flexo plate is contacted by an anilox cylinder 42, wherein the anilox cylinder 42 receives ink from a doctor blade assembly 44.

In fact, the plate cylinder 40, the anilox cylinder 42 and doctor blade assembly 44 are forming one printing unit 36.

Details of the doctor blade assembly 44 are shown in FIG. 2A.

FIG. 2A depicts a detailed top view of a doctor blade assembly 44 which comprises a roller 46 and a doctor blade chamber 48.

The doctor blade chamber 48 is configured to partially receive the roller 46 for applying ink from the doctor blade chamber 48 onto the roller 46.

In detail, the doctor blade chamber 48 is made from a housing 50, the housing 50 having an elongated shape with a longitudinal open side at which a first and a second doctor blade 52 are mounted. The first and the second doctor blade 52 extending in space, parallel relation with the housing 50 defining a reservoir 54 for accommodating a liquid amount of ink (here not shown).

In addition, the doctor blade chamber 48 comprises opposite lateral ends 56 between which the doctor blade chamber 48 extends.

As said before, if the doctor blade chamber 48 is switched into operational mode, the doctor blade chamber 48 is adapted to partially receive the rotatable roller 46.

The roller 46 is shown in detail in FIG. 2B. The roller 46 has a substantially cylindrical shape. Furthermore, a perimeter 58 of the roller 46 substantially equals a perimeter of the doctor blade chamber 48 such that the roller can only partially be accommodated into the reservoir 54.

The roller 46 extends along its rotation axis and is defined by two lateral ends 60 that are located opposite to each other. The distance between the lateral ends 60 equals the distance between the lateral ends 56 of the doctor blade chamber 48.

The doctor blade assembly 44 further comprises a sealing system which includes two first sealing members 62 and two second sealing members 64.

The two first sealing members 62 are each disposed at the opposite lateral ends 56 of the doctor blade chamber 48. Whereas the two second sealing members 64 are each disposed at the opposite lateral ends 60 of the rotatable roller 46.

Each of the two first sealing members 62 is formed as a semicircle shape bearing, each bearing has a curvature which corresponds to the curvature of the perimeter 58 of the rotatable roller 46.

Further, each of the two first sealing members 62 is preferably a lip seal.

Details of the two second sealing members 64 are depicted in FIG. 2B. In particular, each of the two second sealing members 64 is ring shaped and extends continuously around the perimeter 58 of the rotatable roller 46.

In detail, the extension of the ring shaped second sealing member 64 can be seen in FIG. 3.

In addition, it may be that each of the two second sealing members 64 is made from a harder material as each of the two first sealing members 62.

It also may be that each of the two first sealing members 62 is made from a harder material as each of the two second sealing members 64.

Each of the two first sealing members 62 can be made from a slidable material, particularly wherein each of the two first sealing member 62 is made from a material, which is selected from the group consisting of ethylene propylene diene monomer rubber, polyvinylidene fluoride, fleece, polished steel or an alloy thereof, thermoplastic polymer and combinations thereof.

Preferably, each of the two first sealing members 62 is made from ethylene propylene diene monomer rubber which is coated with polyvinylidene fluoride.

It also may be that each of the two second sealing members 64 is made from a material which is selected from the group consisting of ethylene propylene diene monomer rubber, polyvinylidene fluoride, fleece, polished steel or an alloy, thermoplastic polymer and combinations thereof.

The operation principle of the sealing system is described in the following.

In an operational mode of the printing unit 36, the rotatable roller 46 is partially received by the doctor blade chamber 48 such that ink is applied from the reservoir 54 onto the perimeter 58 of the roller 46. In order to cover the perimeter 58 of the roller 46 homogeneously with ink, the roller 46 is rotated around its rotation axis. The ink is subsequently transferred from the reservoir 54 to the roller 46 which transports the ink to a side located opposite to the doctor blade chamber 48. Hereby, the doctor blades 52 removes excess ink. Preferably, the other side is the anilox cylinder 42 which receives the ink and transfers it onto a flexo plate of the plate cylinder 40. The plate cylinder 40 is associated with the flexo plate which finally transfers ink onto the front side of the substrate 18.

In order to prevent a leakage of ink at the opposite lateral ends 56 of the doctor blade chamber 48 the two first sealing members 62 are in rotating contact with each of the second sealing members 64. Since the doctor blade chamber 48 as well as the roller 46 have each an own sealing 62, 64 at their respective later ends 56, 60 the friction at a contact surface between the members 62, 64 is effectively reduced. This enables a longer running time of the doctor blade assembly 44. Thus, also the lifetime of the rotary printing press 10 comprising the doctor blade assembly 44 with the sealing system is increased.

In order to further increase the lifetime of the sealing system, a further lubrication unit 66 is used as shown in more detail in FIG. 4.

The lubrication unit 66 is adapted to lubricate a contact surface between each of the first sealing member 62 and each of the second sealing member 64 with a lubricant.

In detail, lubrication unit 66 has a reservoir unit 68, the reservoir unit 68 is fluidly connected to a pump 70 via a lubrication channel 72. Furthermore, the lubrication channel 72 connects the reservoir unit 68 fluidly to a dispenser unit 74, which is assigned to a contact surface 76 between each of the first sealing members 62 and each of the second sealing members 64.

In the embodiment shown in FIG. 4, the lubrication channel 72 extends along each of the front sides along the housing 50 of the doctor blade chamber 48. Each front side is assigned to one lateral end 56 of the doctor blade chamber 48.

For example, the dispenser unit 74 may be formed as flexible tube having at least one pinhole for releasing the lubricant.

In general, the pump 70 is adapted to transfer the lubricant from the reservoir unit 68 via the lubrication channel 72 to the dispenser unit 74. At the dispenser unit 74 the lubricant is released at the contact surface 76 between each of the first sealing members 62 and each of the second sealing members 64, such that the friction between the sealing members 62, 64 is effectively reduced.

As a lubricant, mineral oil or synthetic oil may be used.

In an alternative embodiment also shown in FIG. 4, the lubrication unit 66 has a compressed gas unit 78. Instead of the lubrication channel 72, a gas channel 80 is used, wherein the dispenser unit 74 is designed as a nozzle 82.

In detail, the compressed gas unit 78 is configured to store a pressurized gas, the compressed gas unit 78 is in fluid connection with the nozzle 82 via the gas channel 80.

In general, the compressed gas unit 78 is adapted to provide a gaseous lubricant between each of the first sealing members 62 and each of the second sealing members 64 such that in operational mode each of the first sealing members 62 and each of the second sealing members 64 are separated by a layer of gas.

As a gaseous lubricant argon, air, nitrogen and mixtures thereof can be used.

The aforementioned lubrication unit 66 can also be integrated into the rotary printing press 10. In principle, there can also be more than one lubrication unit 66 present in the rotary printing press 10. Preferably, each lubrication unit 66 is present for each doctor blade assembly 44. More preferably, one lubrication unit supplies a plurality of doctor blade assembly 44.

The later aspect is depicted in FIG. 1, in which the lubrication unit 66 is part of a lubricant distribution system 84.

The lubricant distribution system 84 comprises a central lubrication unit 66, 78, which is controlled by the control unit 30 through an electric connection 32.

In particular, the control unit 30 is adapted to control the amount of lubricant being released from the lubrication unit 66, 78 in dependency of at least one printing relevant parameter.

The printing relevant parameter may be selected from the group consisting of duration of the printing process, rotation speed of the roller 46, perimeter of the roller 46 used in the printing procedure, ink used in the relevant printing unit 36 in the printing procedure, the amount of ink used in the relevant printing unit 36 in the printing procedure, force applied between the roller 46 and the doctor blade chamber 48 and combinations thereof.

From the lubrication unit 66, 78 a network of lubricant channels 72, 80 extends towards a plurality of doctor blade chambers 48. Each doctor blade chamber 48 is assigned to one respective printing unit 36, wherein the printing units 36 are arranged around the parameter of the central cylinder 38.

Preferably, a plurality of valves 86 are used between the lubrication unit 66, 78 and each of the plurality of doctor blade chambers 48.

In a preferred embodiment, each of the valves 86 can be electronically controlled by the control unit 30. In particular, the control unit 30 is adapted to open or close the respective valve 86 such that the doctor blade chamber 48 assigned to the respective valve 86 is supplied by lubricant or not.

The working principle of the lubricant distribution system 84 can be explained as follows.

In dependency of a printing relevant parameter, the control unit 22 controls the lubrication unit 66, 78 to release a lubricant to at least one doctor blade chamber 48. In particular, the pump 70 is subsequently activated and transfers the lubricant from the lubrication unit 66, in particular the reservoir unit 68, over the lubrication channel 72, 80 to the respective dispenser unit 74. The dispenser unit 74 releases the lubricant at the contact surface 76 between the first sealing member 62 and the second sealing member 64 in the doctor blade assembly 44.

Moreover, the control unit 30 is adapted to close or open certain valves 84 disposed upstream of each of the dispenser units 74, such that selected doctor blade assemblies 44 may be lubricated. Thus, the control unit 30 is adapted to exactly control the dosage of lubricant for each doctor blade assembly 44.

1. A sealing system, the sealing system comprising:
two first sealing members which are each disposed at opposite lateral ends of a doctor blade chamber which in operational mode is adapted to partially receive a rotatable roller for applying ink from the doctor blade chamber onto the rotatable roller, and
two second sealing members which are each disposed at opposite lateral ends of the rotatable roller which in operational mode is configured to extend partially into the doctor blade chamber for receiving ink from the doctor blade chamber,
wherein in operational mode, each of the two first sealing members is in rotating contact with each of the two second sealing members such that a leakage of ink at the opposite lateral ends of the doctor blade chamber is prevented.

2. The sealing system according to claim 1, wherein each of the two first sealing members is formed as a semicircle shaped bearing, each bearing has a curvature which corresponds to a curvature of a perimeter of the rotatable roller.

3. The sealing system according to claim 1, wherein each of the two first sealing members is a lip seal.

4. The sealing system according to claim 1, wherein each of the two second sealing members is ring-shaped and extends continuously around a perimeter of the rotatable roller.

5. The sealing system according to claim 1, wherein each of the two second sealing members is made from a harder material as each of the two first sealing members.

6. The sealing system according to claim 1, wherein each of the two first sealing members is made from a harder material than each of the two second sealing members.

7. The sealing system according to claim 1, wherein each of the two first sealing members is made from a slidable material, particularly each of the two first sealing members is made from a material which is selected from a group consisting of ethylene propylene diene monomer rubber, polyvinylidene fluoride, fleece, polished steel or an alloy, thermoplastic polymer, and a combination thereof.

8. The sealing system according to claim 1, wherein the sealing system further comprises a lubrication unit which is adapted to lubricate a contact surface between each of the two first sealing members and each the two second sealing members with a lubricant.

9. The sealing system according to claim 8, wherein the lubrication unit has a reservoir unit in which the lubricant is stored which is selected from a group consisting of mineral oil and synthetic oil,
wherein the lubrication unit further comprises a pump assigned to the reservoir unit, the reservoir unit being fluidly connected to at least one lubrication channel, the at least one lubrication channel extending from the reservoir unit towards a dispenser unit which is assigned to the contact surface of each of the two first sealing members and each of the two second sealing members.

10. The sealing system according to claim 8, wherein the lubrication unit has a compressed gas unit in which pressurized gas is stored, wherein the lubrication unit further comprises a gas channel and a nozzle which are fluidly connected to each other, and
wherein the compressed gas unit is adapted to provide a gaseous lubricant between each of the two first sealing members and each the two second sealing members such that in operation mode each of the two first sealing members and each the two second sealing members are separated by a layer of gas.

11. The sealing system according to claim 10, wherein the gaseous lubricant is selected from a group of argon, air, nitrogen, and mixtures thereof.
